(19) United States
(12) Patent Application Publication
(10) Pub. No.: US 2025/0226626 A1
(43) Pub. Date: Jul. 10, 2025

(54) CONNECTION STRUCTURE, ASSEMBLY, AND OPERATION JIG

(71) Applicant: Yazaki Corporation, Tokyo (JP)

(72) Inventor: Hayato YAMAGUCHI, Makinohara-shi (JP)

(73) Assignee: Yazaki Corporation, Tokyo (JP)

(21) Appl. No.: 18/988,041

(22) Filed: Dec. 19, 2024

(30) Foreign Application Priority Data
Jan. 10, 2024 (JP) 2024-001743

(51) Int. Cl. H01R 25/16; H01M 50/507; H01R 4/30; H01R 4/48

(52) U.S. Cl. CPC H01R 25/161; H01R 4/48; H01M 50/507; H01R 4/30

(57) ABSTRACT

A connection structure includes: a first bus bar including a first through hole; a second bus bar including a second through hole; a connection member including a shaft, a first overhanging portion, and a second overhanging portion; and an elastic member through which the shaft penetrates. The elastic member has an outer peripheral diameter larger than the circumference of the virtual circle and an inner peripheral diameter smaller than a maximum diameter of the first overhanging portion. The second overhanging portion is insertable into the first through hole and the second through hole while being fitted into a recess defined by the first recessed surface of the first through hole and the second recessed surface of the second through hole at a first rotational position; and the second overhanging portion overlaps a second pressed surface when viewed in a penetrating direction at a second rotational position.

### BACKGROUND OF THE INVENTION

### Field of the Invention

Embodiments of the present invention relate to a connection structure, an assembly, and an operation jig.

This application claims priority to Japanese Patent Application No. 2024-001743 filed in Japan on Jan. 10, 2024, the contents of which are incorporated herein by reference.

### Description of Related Art

It is widely known that a battery pack as a power supply source is connected to a device. For example, Japanese Unexamined Patent Application, First Publication No. 2018-144524 discloses that a battery module is connected to a fuse contactor unit of an electric vehicle.

### SUMMARY OF THE INVENTION

In the assembly disclosed in Japanese Unexamined Patent Application, First Publication No. 2018-144524, a power supply-side male terminal provided in a battery module is directly attached to and detached from each of a plurality of power reception-side female terminals connected to a fuse contactor unit. However, in such a connection structure including terminals, the contact pressure between conductors of both units cannot be secured in some cases.

An embodiment of the present invention provides a connection structure, an assembly, and an operation jig that easily secure the contact pressure of a conductor.

A connection structure according to an embodiment of the present invention includes: a first bus bar having a first facing surface, a first pressed surface on a back side of the first facing surface, and a first through hole penetrating from the first pressed surface to the first facing surface in a penetrating direction that is a direction intersecting the first facing surface; a second bus bar having a second facing surface facing the first facing surface, a second pressed surface on a back side of the second facing surface, and a second through hole penetrating from the second facing surface to the second pressed surface in the penetrating direction; a connection member including a shaft that has a first end and a second end and extends in the penetrating direction from the first end to the second end so as to communicate with the first through hole and the second through hole, a first overhanging portion that protrudes from the first end in a radial direction of the shaft, and a second overhanging portion that protrudes in the radial direction; and an elastic member through which the shaft penetrates. The first through hole is defined by a first peripheral surface having a cross-sectional shape along a circumference of a virtual circle and extending from the first facing surface to the first pressed surface, and a first recessed surface having a cross-sectional shape recessed from the circumference and extending from the first facing surface to the first pressed surface; the second through hole is defined by a second peripheral surface having a cross-sectional shape along the circumference and extending from the second facing surface to the second pressed surface, and a second recessed surface having a cross-sectional shape recessed from the circumference and extending from the second facing surface to the second pressed surface; the elastic member has an outer peripheral diameter larger than the circumference and an inner peripheral diameter smaller than a maximum diameter of the first overhanging portion; the second overhanging portion is insertable into the first through hole and the second through hole while being fitted into a recess defined by the first recessed surface and the second recessed surface at a first rotational position around an axis of the shaft; and the second overhanging portion overlaps the second pressed surface when viewed in the penetrating direction at a second rotational position around the axis.

According to the connection structure, the assembly, and the operation jig of one embodiment of the present invention, it is easy to secure the contact pressure of a conductor.

### BRIEF DESCRIPTION OF THE DRAWINGS

FIG. 1 is a perspective view of an assembly before fastening according to each embodiment.

FIG. 2 is a perspective view of a connection structure before connection according to the first embodiment.

FIG. 3 is a plan view of the connection structure before connection according to the first embodiment.

FIG. 4 is a perspective view of a connection member and an elastic member according to the first embodiment.

FIG. 5 is a perspective view of the connection structure after connection according to the first embodiment.

FIG. 6 is a plan view of the connection structure after connection according to the first embodiment.

FIG. 7 is a perspective view of an assembly according to a modification of the first embodiment.

FIG. 8 is a perspective view of a connection structure before connection according to a second embodiment.

FIG. 9 is a perspective view of a connection structure after connection according to the second embodiment.

FIG. 10 is a perspective view of a connection structure and an operation jig according to a third embodiment.

FIG. 11 is a perspective view of a bar according to the third embodiment.

FIG. 12 is a plan view of part of the connection structure and the operation jig according to the third embodiment.

FIG. 13 is a plan view of the connection structure before connection according to the third embodiment.

FIG. 14 is a plan view of the connection structure after connection according to the third embodiment.

FIG. 15 is a plan view of an arcuate opening and a connection structure according to a modification of the third embodiment.

FIG. 16 is a perspective view of part of an operation jig according to a modification of the third embodiment.

### DETAILED DESCRIPTION OF THE INVENTION

### First Embodiment

Hereinafter, a connection structure and an assembly according to an embodiment will be described with reference to the drawings.

### (Constitution of Assembly)

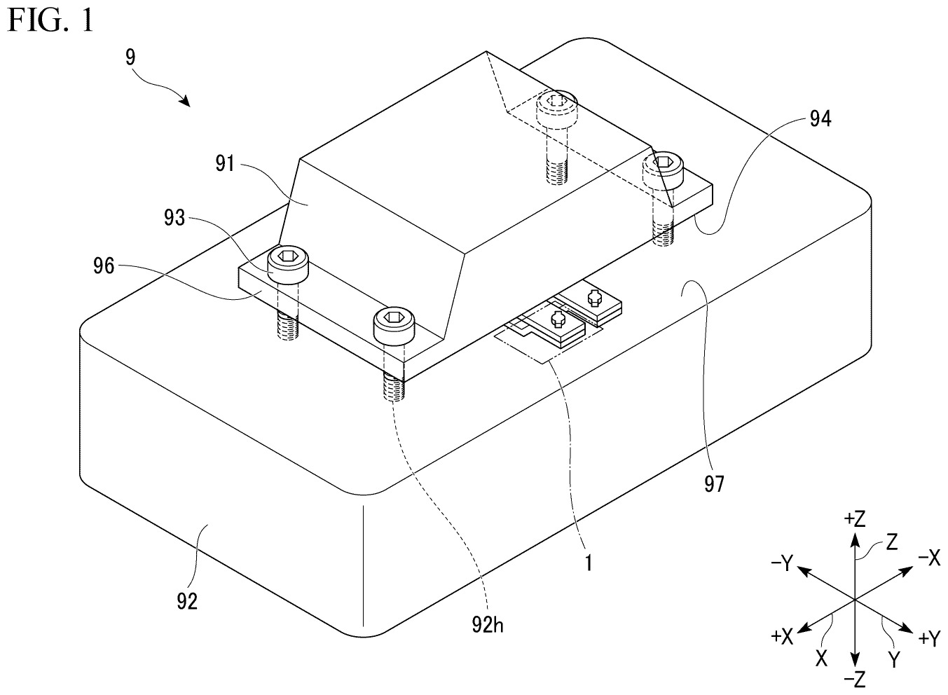

As illustrated in FIG. 1, an assembly 9 of the present embodiment includes a plurality of connection structures 1, a device 91, a battery pack 92, and a fastener 93. The device 91 and the battery pack 92 are fastened by the fastener 93, whereby the assembly 9 is unitized. For example, the assembly 9 may be mounted on a mobility unit such as an electric vehicle.

### (Device)

The device 91 receives and transmits power from and to the battery pack 92. For example, the device 91 may be a high-voltage device such as a high-voltage junction box (J/B), an on-board charger (OBC), or a DC-DC converter. The device 91 has a first installation surface 94 on a side facing the battery pack 92.

Hereinafter, a direction in which the first installation surface 94 faces is referred to as a Z direction. Hereinafter, the Z direction is also referred to as a “penetrating direction”. Further, directions intersecting each other in a plane facing the Z direction are defined as an X direction and a Y direction. Hereinafter, the X direction is also referred to as a “parallel direction”. For example, the X direction, the Y direction, and the Z direction may be directions orthogonal to each other. For example, the Z direction may be the “vertical direction”. For example, the first installation surface 94 may be a plane facing downward.

The first installation surface 94 is an insulating surface made of an insulator material. For example, the first installation surface 94 may be an insulating housing, a partially insulating cover, or the like.

The device 91 has flanges 96 protruding on both sides in the X direction. The device 91 and the battery pack 92 are fastened together by the fastener 93 penetrating the flange 96.

### (Constitution of Battery Pack)

The battery pack 92 includes a plurality of battery cells. The battery pack 92 has a second installation surface 97 on a side facing the device 91. The second installation surface 97 faces the first installation surface 94. For example, the second installation surface 97 may be a plane facing upward.

The battery pack 92 has a screw hole 92h in the second installation surface 97. The fastener 93 passing through the flange 96 is tightened into the screw hole 92h.

The second installation surface 97 is an insulating surface made of an insulator material. For example, the second installation surface 97 may be an insulating housing, a partially insulating cover, or the like.

### (Constitution of Connection Structure)

The plurality of connection structures 1 are structures for electrically connecting the device 91 and the battery pack 92. The plurality of connection structures 1 are provided side by side in a parallel direction. Each connection structure 1 is provided between the first installation surface 94 and the second installation surface 97.

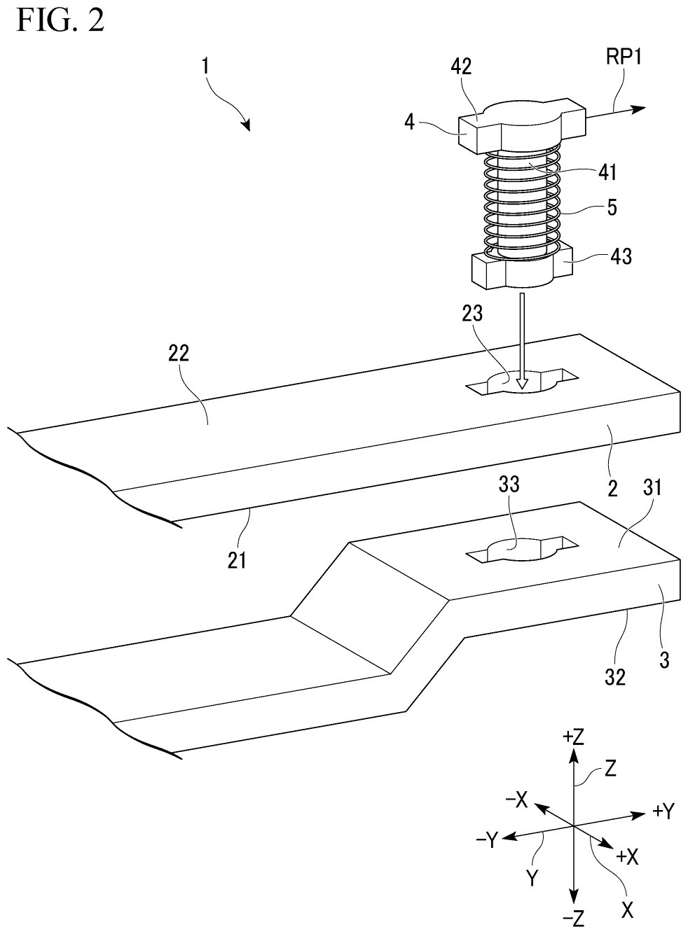

As illustrated in FIG. 2, each connection structure 1 includes a device bus bar 2 (first bus bar), a battery bus bar 3 (second bus bar), a connection member 4, and an elastic member 5.

### (Structure of Device Bus Bar)

The device bus bar 2 is a conductor connected to the device 91. Specifically, the device bus bar 2 is electrically connected to an electrode included in the device 91. The plurality of device bus bars 2 are provided on the first installation surface 94 side by side in the X direction. The device bus bar 2 extends in the Y direction while being in contact with the first installation surface 94. For example, the device bus bar 2 may protrude from the device 91 in the +Y direction. The device bus bar 2 is formed of a conductive material such as copper or aluminum.

The device bus bar 2 has a first facing surface 21, a first pressed surface 22, and a first through hole 23.

The first facing surface 21 is a surface to be brought into contact with the battery bus bar 3. The first facing surface 21 has a plane parallel to the XY plane extending in the Y direction. The first facing surface 21 is a plate surface on the −Z direction side among plate surfaces of the device bus bar 2.

The first pressed surface 22 is a surface pressed by the connection member 4 toward the battery bus bar 3 when the device bus bar 2 and the battery bus bar 3 are connected by the connection member 4. The first pressed surface 22 is a surface on the back side of the first facing surface 21. The first pressed surface 22 has a plane parallel to the XY plane extending in the Y direction. The first pressed surface 22 is a plate surface on the +Z direction side among the plate surfaces of the device bus bar 2.

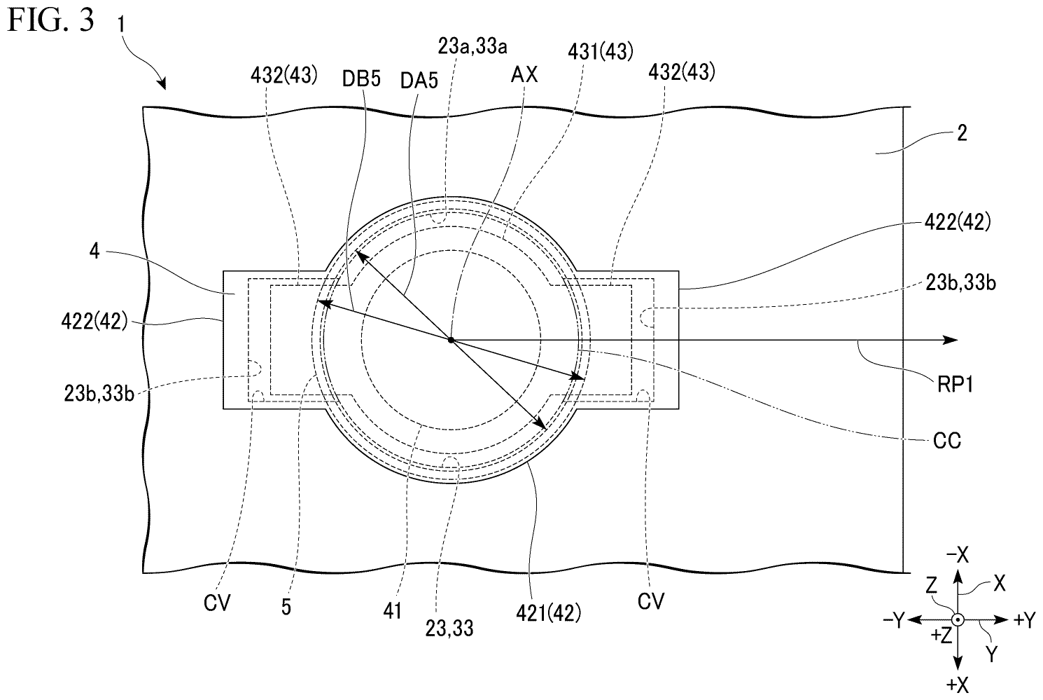

The first through hole 23 is a hole through which the connection member 4 passes. The first through hole 23 penetrates from the first pressed surface 22 to the first facing surface 21 in the Z direction. As illustrated in FIG. 3, the first through hole 23 is defined by a first peripheral surface 23a and a pair of first recessed surfaces 23b.

The first peripheral surface 23a has a cross-sectional shape along the circumference of a virtual circle CC and extends from the first facing surface 21 to the first pressed surface 22.

The pair of first recessed surfaces 23b are arranged in the Y direction. The pair of first recessed surfaces 23b face each other in the Y direction. Each of the first recessed surfaces 23b has a cross-sectional shape recessed in the Y direction away from the virtual circle CC from the circumference of the virtual circle CC, and extends in the Z direction from the first facing surface 21 to the first pressed surface 22. For example, each of the first recessed surfaces 23b may be recessed in a rectangular shape from the circumference of the virtual circle CC when viewed in the Z direction.

The first through hole 23 thus defined may have, for example, a keyhole shape.

### (Structure of Battery Bus Bar)

The battery bus bar 3 is a conductor connected to the battery pack 92. Specifically, the battery bus bar 3 is electrically connected to an electrode included in the battery pack 92. The plurality of battery bus bars 3 are provided on the second installation surface 97 side by side in the X direction. The battery bus bar 3 extends in the Y direction on the second installation surface 97. The battery bus bar 3 faces the corresponding device bus bar 2 in a portion extending in the Y direction.

For example, the battery bus bar 3 may protrude from the device 91 in the +Y direction. In addition, at the protruding tip, the battery bus bar 3 may extend in the +Y direction while being bent so as to have a step in the +Z direction in the middle. The battery bus bar 3 is formed of a conductive material such as copper or aluminum.

As illustrated in FIG. 2, the battery bus bar 3 includes a second facing surface 31, a second pressed surface 32, and a second through hole 33.

The second facing surface 31 is a surface to be brought into contact with the first facing surface 21. The second facing surface 31 has a plane parallel to the XY plane extending in the Y direction at least at a position facing the first facing surface 21 in the Z direction. The second facing surface 31 is a plate surface on the +Z direction side among plate surfaces of the battery bus bar 3.

The second pressed surface 32 is a surface pressed by the connection member 4 toward the first facing surface 21 when the device bus bar 2 and the battery bus bar 3 are connected by the connection member 4. The second pressed surface 32 is a surface on the back side of the second facing surface 31. The second pressed surface 32 has a plane parallel to the XY plane extending in the Y direction at least at a position where the second facing surface 31 faces the first facing surface 21 in the Z direction. The second pressed surface 32 is a plate surface on the −Z side among the plate surfaces of the battery bus bar 3.

The second through hole 33 is a hole through which the connection member 4 passes. The second through hole 33 penetrates from the second facing surface 31 to the second pressed surface 32 in the Z direction. Specifically, as illustrated in FIG. 3, the second through hole 33 is defined by a second peripheral surface 33a and a pair of second recessed surfaces 33b.

The second peripheral surface 33a has a cross-sectional shape along the circumference of the virtual circle CC and extends from the second facing surface 31 to the second pressed surface 32. For example, the second peripheral surface 33a may be coaxial with the first peripheral surface 23a and have the same diameter.

The pair of second recessed surfaces 33b are arranged in the Y direction. The pair of second recessed surfaces 33b face each other in the Y direction. Each of the second recessed surfaces 33b has a cross-sectional shape recessed in the Y direction away from the virtual circle CC from the circumference of the virtual circle CC, and extends from the second facing surface 31 to the second pressed surface 32. For example, the pair of second recessed surfaces 33b may have the same shape at the same position in the X direction and the Y direction and having the same dimension in the X direction and the Y direction as the pair of first recessed surfaces 23b. For example, each of the second recessed surfaces 33b may be recessed in a rectangular shape from the circumference of the virtual circle CC when viewed in the Z direction.

The second through hole 33 thus defined may have, for example, a keyhole shape having the same dimension as the first through hole 23.

### (Structure of Connection Member)

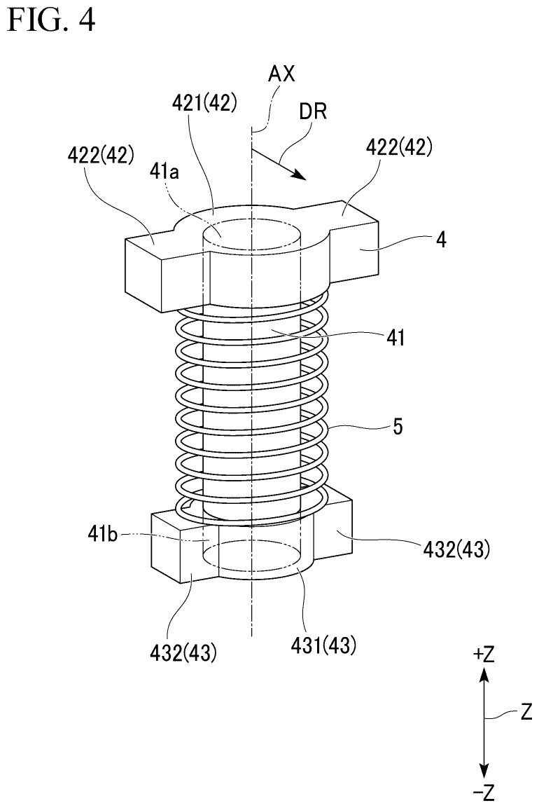

The connection member 4 is a member for connecting the device bus bar 2 and the battery bus bar 3. As illustrated in FIGS. 3 and 4, the connection member 4 includes a shaft 41, a first overhanging portion 42, and a second overhanging portion 43. The connection member 4 is formed of a metal material.

The shaft 41 has a first end 41a and a second end 41b. The shaft 41 extends in the Z direction from the first end 41a to the second end 41b. The shaft 41 extends through the first through hole 23 and the second through hole 33 in the Z direction so as to communicate with the first through hole 23 and the second through hole 33. Specifically, the shaft 41 has a columnar shape. This columnar shape has an outer diameter smaller than the inner diameters of the first through hole 23 and the second through hole 33, and a length in an axis AX direction longer than a total length of the hole length of the first through hole 23 and the hole length of the second through hole 33.

The first overhanging portion 42 protrudes from the first end 41a in a radial direction DR which is the radial direction of the shaft 41. For example, the first overhanging portion 42 may be integrally formed with the shaft 41. For example, the first overhanging portion 42 may have a maximum diameter larger than the maximum diameter of the first through hole 23. For example, the first overhanging portion 42 may have a maximum diameter larger than the maximum diameter of the second through hole 33. The first overhanging portion 42 includes a first disk 421 and a pair of first protrusions 422.

The first disk 421 has a disk shape. For example, the first disk 421 may have an outer peripheral diameter larger than the diameter of the first peripheral surface 23a of the first through hole 23. For example, the first disk 421 may have an outer peripheral diameter larger than the diameter of the second peripheral surface 33a of the second through hole 33. For example, the first disk 421 may have an outer peripheral diameter larger than an inner peripheral diameter DA5 of the elastic member 5.

The pair of first protrusions 422 protrude in directions opposite to each other. Each of the first protrusions 422 protrudes from the first disk 421 in one direction in the radial direction DR. For example, each of the first protrusions 422 may protrude from the first disk 421 in a rectangular shape when viewed in the Z direction.

The second overhanging portion 43 protrudes from the second end 41b in the radial direction DR. For example, the second overhanging portion 43 may be integrally formed with the shaft 41. The second overhanging portion 43 includes a second disk 431 and a pair of second protrusions 432. When viewed in the Z direction, the outline of the second overhanging portion 43 has a shape similar to the outline of the first overhanging portion 42. The outline of the second overhanging portion 43 is slightly smaller than the outline of the first overhanging portion 42 so as to be within the outline of the first overhanging portion 42.

The second disk 431 has a disk shape. The second disk 431 has an outer peripheral diameter smaller than the circumference of the virtual circle CC. For example, the second disk 431 may have an outer peripheral diameter slightly smaller than the diameter of the first peripheral surface 23a of the first through hole 23. For example, the second disk 431 may have an outer peripheral diameter slightly smaller than the diameter of the second peripheral surface 33a of the second through hole 33.

The pair of second protrusions 432 protrude in directions opposite to each other. Each of the second protrusions 432 protrudes from the second disk 431 in the radial direction DR. Each of the second protrusions 432 protrudes in one direction in the radial direction DR in which the corresponding first protrusion 422 protrudes.

The pair of second protrusions 432 protrude in such a shape as to fit into a pair of recesses CV defined by the pair of first recessed surfaces 23b and the pair of second recessed surfaces 33b.

For example, each of the second protrusions 432 may protrude from the second disk 431 in a rectangular shape when viewed in the Z direction. For example, each of the second protrusions 432 may have a protrusion width smaller than the recess width of the corresponding first recessed surface 23b when viewed in the Z direction. For example, each of the second protrusions 432 may have a protrusion length smaller than the recess depth of the corresponding first recessed surface 23b when viewed in the Z direction. For example, each of the second protrusions 432 may have a protrusion width smaller than the recess width of the corresponding second recessed surface 33b when viewed in the Z direction. For example, each of the second protrusions 432 may have a protrusion length smaller than the recess depth of the corresponding second recessed surface 33b when viewed in the Z direction.

At a first rotational position RP1 around the axis AX of the shaft 41, each of the second overhanging portions 43 can be inserted into the first through hole 23 and the second through hole 33 while being fitted into the corresponding recess CV of the pair of recesses CV.

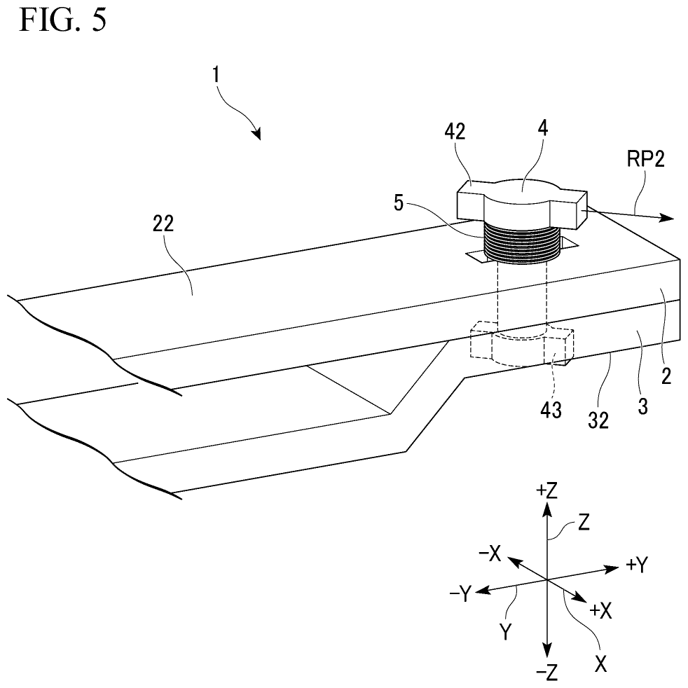

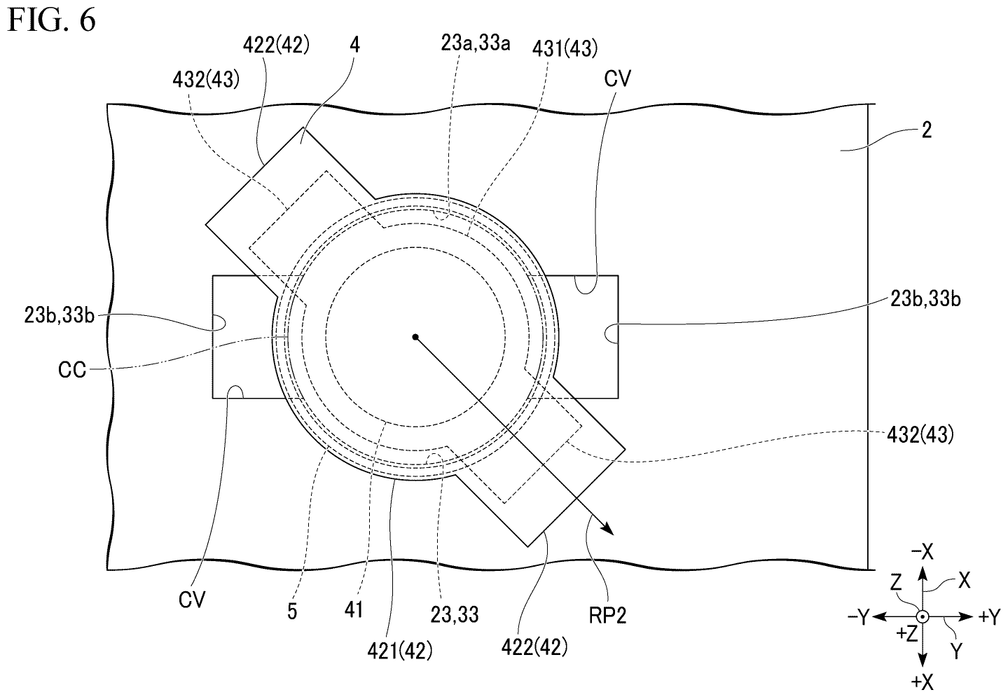

On the other hand, as illustrated in FIGS. 5 and 6, at a second rotational position RP2 around the axis AX, the second overhanging portion 43 overlaps the second pressed surface 32 when viewed in the Z direction. Specifically, at the second rotational position RP2, a portion of the second overhanging portion 43 having the pair of second protrusions 432 partially overlaps the second pressed surface 32 when viewed in the Z direction. Due to this overlap, at the second rotational position RP2, the connection member 4 is caught on the second pressed surface 32 without being pulled out in the +Z direction from the battery bus bar 3.

Note that the first overhanging portion 42 has a shape that does not enter the first through hole 23 from the first rotational position RP1 to the second rotational position RP2 regardless of whether or not the elastic member 5 is present, and has a shape that interferes with the first through hole 23.

### (Structure of Elastic Member)

The elastic member 5 is a member for applying a bias to press the device bus bar 2 toward the battery bus bar 3 when the device bus bar 2 and the battery bus bar 3 are connected by the connection member 4. As illustrated in FIGS. 3 and 4, the shaft 41 of the connection member 4 penetrates the elastic member 5. The elastic member 5 has an outer peripheral diameter DB5 larger than the circumference of the virtual circle CC. Moreover, the elastic member 5 has the inner peripheral diameter DA5 smaller than the maximum diameter of the first overhanging portion 42. As described above, for example, the inner peripheral diameter DA5 may be smaller than the diameter of the first disk 421 of the first overhanging portion 42. For example, the elastic member 5 may be formed of a conductive material such as metal.

For example, the elastic member 5 may be a coil spring that is coaxial with the shaft 41 and turns and extends in the axis AX direction. For example, the coil spring may be inserted into the shaft 41 by being pushed and rotated from one end of the connection member 4. For example, the coil spring may be inserted into the shaft 41 while being enlarged in diameter by twisting both ends in opposite directions.

### (Connection Method)

First, while directing the second overhanging portion 43 toward the first pressed surface 22, the operator inserts the connection member 4 from the first pressed surface 22 side into the first through hole 23 and the second through hole 33 at the first rotational position RP1, and causes the connection member 4 to communicate with the first through hole 23 and the second through hole 33.

Here, the elastic member 5 is larger than the circumference of the virtual circle CC. That is, since the elastic member 5 has the outer peripheral diameter DB5 larger than the diameter of the first peripheral surface 23a of the first through hole 23, the elastic member 5 is compressed in the axis AX direction between the first overhanging portion 42 and the first pressed surface 22 at the time of insertion. On the other hand, at the time of insertion, the elastic member 5 applies a bias to the first pressed surface 22 so as to press the first pressed surface 22 toward the battery bus bar 3.

The operator further inserts the connection member 4 against the bias of the elastic member 5 until the second overhanging portion 43 protrudes from the second pressed surface 32. When the second overhanging portion 43 protrudes, the operator rotates the inserted connection member 4 around the axis AX with respect to the device bus bar 2 and the battery bus bar 3 from the first rotational position RP1 to the second rotational position RP2 as illustrated in FIGS. 5 and 6.

### (Operation and Effect)

According to the present embodiment, in the connection structure 1, the device bus bar 2 and the battery bus bar 3 can be connected by the connection member 4 such that the first facing surface 21 and the second facing surface 31 are brought into surface contact with each other in a state where the elastic member 5 is provided between the first overhanging portion 42 and the first pressed surface 22. With such a connection structure 1, the inserted connection member 4 can maintain the connection state between the device bus bar 2 and the battery bus bar 3 while the elastic member 5 biases the device bus bar 2 toward the battery bus bar 3. Therefore, according to the connection structure 1, it is easy to secure the contact pressure between the device bus bar 2 as the first bus bar and the battery bus bar 3 as the second bus bar.

As a comparative example, assume that the structure of the assembly is a structure in which a connector is provided in a battery pack and a vehicle body side connector and a battery side connector are connected when the battery pack is attached to the vehicle body as disclosed in Japanese Unexamined Patent Application, First Publication No. 2018-144524. With such a structure of the comparative example, when there are multiple connection points, the fitting state of each connector cannot be checked and there may be a half-fitted connector, a very large insertion force may be needed at the time of collective connection, or the component cost may be increased.

In contrast to this comparative example, the assembly 9 of the present embodiment has a structure in which the inserted connection member 4 maintains the connection state between the device bus bar 2 and the battery bus bar 3 while the elastic member 5 biases the device bus bar 2 toward the battery bus bar 3. With this structure, even when there are multiple connection points, it is easy to secure the contact pressure between each device bus bar 2 and the associated battery bus bar 3 while suppressing the fastening pressure and the number of components.

In particular, when the device 91 is a high-voltage device, the electrical connection between the device 91 and the battery pack 92 is electrical connection between bus bars in many parts, and thus it is effective to secure the contact pressure between the device bus bar 2 and the battery bus bar 3 as in the present embodiment.

According to the present embodiment, the first disk 421 has an outer peripheral diameter larger than the diameter of the first peripheral surface 23a of the first through hole 23. Due to such an outer peripheral diameter, the first disk 421 is hardly fitted into the first through hole 23. Therefore, according to the connection structure 1, it is easy to connect the device bus bar 2 as the first bus bar and the battery bus bar 3 as the second bus bar, and it is easy to secure the contact pressure.

According to the present embodiment, the second protrusion 432 protrudes in one direction in the radial direction in which the first protrusion 422 protrudes. That is, the first protrusion 422 and the second protrusion 432 protrude in the same radial direction DR. With such a protruding structure, it is easy to estimate the relationship between the rotational positions of the second protrusion 432 and the second through hole 33 by visually recognizing the relationship between the rotational positions of the first protrusion 422 and the first through hole 23. Therefore, it is easy to confirm the connection state between the device bus bar 2 as the first bus bar and the battery bus bar 3 as the second bus bar by the connection member 4.

According to the present embodiment, the first overhanging portion 42 and the second overhanging portion 43 have similar shapes when viewed in the Z direction. With such similar shapes, it is easy to estimate the overlapping state of the second overhanging portion 43 and the second through hole 33 by visually recognizing the overlapping state of the first overhanging portion 42 and the first through hole 23 when viewed in the Z direction. Therefore, it is easy to confirm the connection state between the device bus bar 2 as the first bus bar and the battery bus bar 3 as the second bus bar by the connection member 4.

### (Modification)

In an example of the present embodiment, the device bus bar 2 and the battery bus bar 3 are connected to each other outside the device 91 by connecting the device bus bar 2 and the battery bus bar 3 protruding in the +Y direction from the device 91. Note, however, that the connection structure 1 may be configured in any manner as long as the connection member 4 connects the device bus bar 2 and the battery bus bar 3.

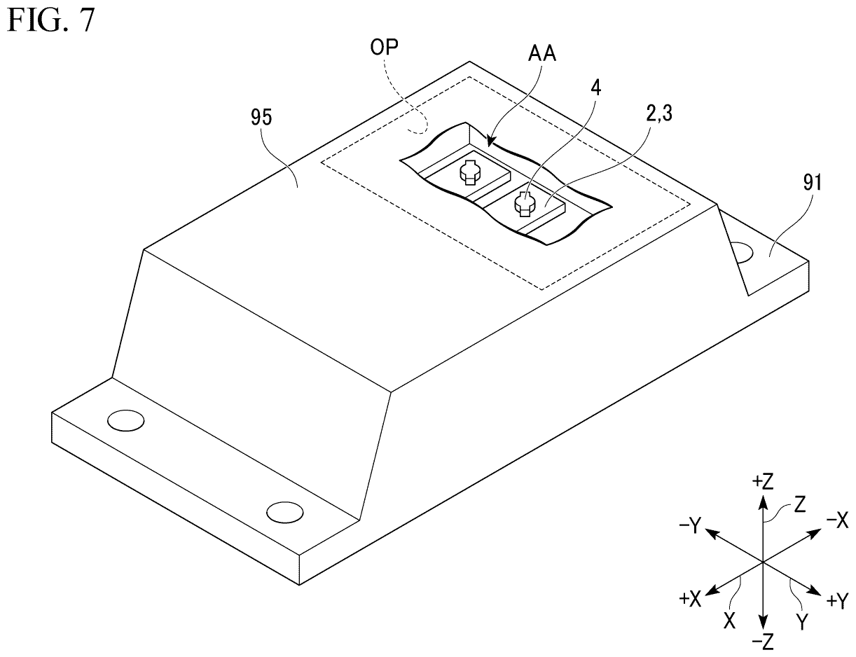

As a modification, as illustrated in FIG. 7, a connection member 4 may be provided in a region AA where an opening OP of a device 91 is opened when viewed in the Z direction, so that a device bus bar 2 and a battery bus bar 3 may be connected in a housing 95 of the device 91. The opening OP opens to the battery bus bar 3 from the +Z direction side in the housing 95 of the device 91. For example, the device bus bar 2 may protrude in the −X direction into the region having the opening OP when viewed in the Z direction. The battery bus bar 3 may protrude in the −X direction into the region having the opening OP when viewed in the Z direction. The operator connects the device bus bar 2 and the battery bus bar 3 by the connection member 4, and then closes the housing 95. According to such a modification, the connection member 4 can connect the device bus bar 2 and the battery bus bar 3 in the region of the device 91. Therefore, the device bus bar 2, the battery bus bar 3, and the connection structure can be made compact.

In an example of the present embodiment, the first overhanging portion 42, the second overhanging portion 43, and the shaft 41 are integrally formed. Note, however, that the connection member 4 may be configured in any manner as long as the first overhanging portion 42 and the second overhanging portion 43 protrude from the shaft 41.

As a modification, a first overhanging portion 42 and a shaft 41 may be formed separately. In the case of forming the first overhanging portion 42 and the shaft 41 separately, a connection member 4 may be configured by fastening a female screw provided on one of the first overhanging portion 42 and the shaft 41 to a male screw provided on the other. Furthermore, the fastening force may be increased by providing a double nut in the male screw. Such fastening may be performed after an elastic member 5 is inserted into the shaft 41.

### Second Embodiment

Hereinafter, a connection structure of an embodiment will be described with reference to the drawings. Each constitution of a connection structure 101 of the present embodiment has a constitution similar to those of the connection structure 1 of the first embodiment except for the following points, is similarly connected, and has a similar operation and effect.

While the connection structure 1 of the first embodiment is configured such that the connection member 4 is inserted from the device bus bar side, the connection structure 101 of the present embodiment is configured such that a connection member 4 is inserted from the battery bus bar side. That is, the connection structure 101 of the present embodiment is different from the connection structure 1 of the first embodiment in that a battery bus bar 103 is provided as the first bus bar instead of the device bus bar 2. On the other hand, the connection structure 101 of the present embodiment is different from the connection structure 1 of the first embodiment in that a device bus bar 102 is provided as a second bus bar instead of the battery bus bar 3.

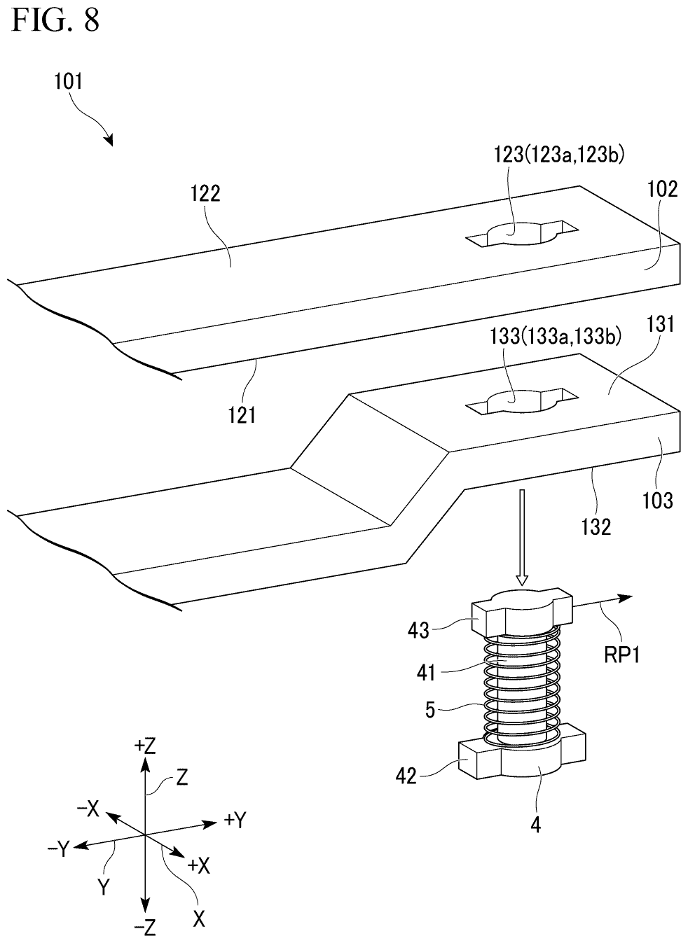

(Constitution of Connection Structure) As illustrated in FIG. 8, each connection structure 101 includes the battery bus bar 103 (first bus bar), the device bus bar 102 (second bus bar), the connection member 4, and an elastic member 5.
(Constitution of Battery Bus Bar) The battery bus bar 103 has a first facing surface 131, a first pressed surface 132, and a first through hole 133.

The first facing surface 131 is a surface to be brought into contact with the device bus bar 102. The first facing surface 131 has a constitution similar to the second facing surface 31.

The first pressed surface 132 is a surface pressed by the connection member 4 toward the device bus bar 102 when the device bus bar 102 and the battery bus bar 103 are connected by the connection member 4. The first pressed surface 132 has a constitution similar to the second pressed surface 32.

The first through hole 133 is a hole through which the connection member 4 passes. The first through hole 133 has a constitution similar to the second through hole 33. Specifically, the first through hole 133 is defined by a first peripheral surface 133a having a constitution similar to the second peripheral surface 33a and a pair of first recessed surfaces 133b having a constitution similar to the pair of second recessed surfaces 33b.

### (Constitution of Battery Bus Bar)

The device bus bar 102 includes a second facing surface 121, a second pressed surface 122, and a second through hole 123.

The second facing surface 121 is a surface to be brought into contact with the battery bus bar 103. The second facing surface 121 has a constitution similar to the first facing surface 21.

The second pressed surface 122 is a surface pressed by the connection member 4 toward the battery bus bar 103 when the device bus bar 102 and the battery bus bar 103 are connected by the connection member 4. The second pressed surface 122 has a constitution similar to the first pressed surface 22.

The second through hole 123 is a hole through which the connection member 4 passes. The second through hole 123 penetrates from the second pressed surface 122 to the second facing surface 121 in the Z direction. The second through hole 123 has a constitution similar to the first through hole 23. Specifically, the second through hole 123 is defined by a first peripheral surface 123a having a constitution similar to the first peripheral surface 23a and a pair of first recessed surfaces 123b having a constitution similar to the pair of first recessed surfaces 23b.

### (Connection Method)

First, the operator inserts the battery bus bar 103 and the device bus bar 102 into the waiting connection member 4 at a first rotational position RP1. Specifically, the operator passes the first through hole 133 and the second through hole 123 so that the connection member 4 is inserted at the first rotational position RP1 while directing the first pressed surface 132 toward the waiting second overhanging portion 43. With this insertion, the connection member 4 is inserted into the first through hole 133 and the second through hole 123 from the first pressed surface 132 side. With this insertion, the connection member 4 communicates with the first through hole 133 and the second through hole 123.

Next, the operator inserts the first through hole 133 and the second through hole 123 into the connection member 4 against the bias of the elastic member 5 until the second overhanging portion 43 protrudes from the second pressed surface 122.

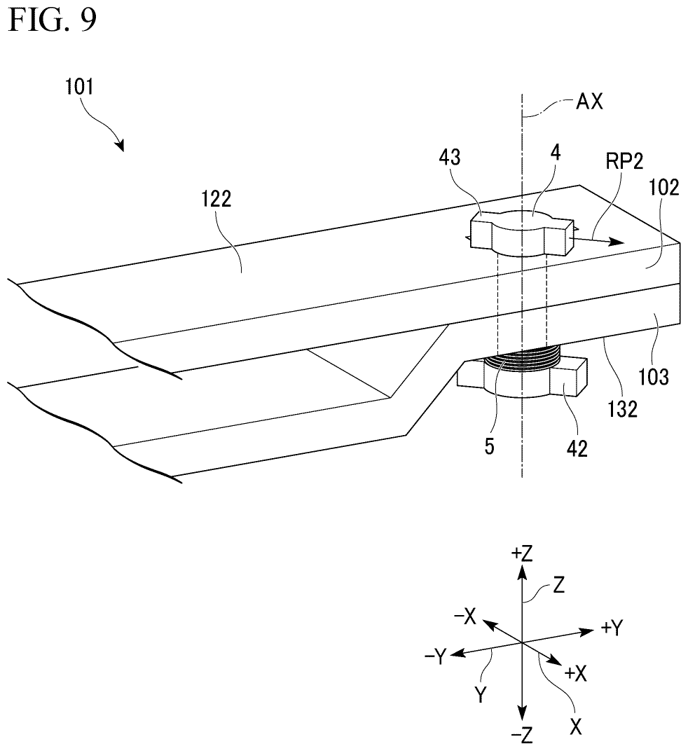

When the second overhanging portion 43 protrudes, the operator rotates the connection member 4 around the axis AX with respect to the device bus bar 102 and the battery bus bar 103 from the first rotational position RP1 to the second rotational position RP2 as illustrated in FIG. 9.

### (Operation and Effect)

In the connection structure 1, the device bus bar 102 and the battery bus bar 103 can be connected by the connection member 4 such that the first facing surface 131 and the second facing surface 121 are brought into surface contact with each other in a state where the elastic member 5 is provided between the first overhanging portion 42 and the first pressed surface 132. With such a connection structure, a connection state between the device bus bar 102 and the battery bus bar 103 can be maintained by the inserted connection member 4 while biasing the device bus bar 102 toward the battery bus bar 103 by the elastic member 5. Therefore, according to the connection structure 1, it is easy to secure the contact pressure between the battery bus bar 103 as the first bus bar and the device bus bar 102 as the second bus bar.

In addition, according to the present embodiment, the connection member 4 has effects similar to those of the first embodiment.

### Third Embodiment

Hereinafter, an operation jig according to an embodiment will be described with reference to the drawings. A plurality of connection structures 1 operated by an operation jig 7 of the present embodiment have constitutions similar to each constitution of the connection structure 1 of the first embodiment, are similarly connected, and have a similar operation and effect. In addition, a plurality of connection structures 101 operated by the operation jig 7 of the present embodiment have constitutions similar to each constitution of the connection structure 101 of the second embodiment, are similarly connected, and have a similar operation and effect.

### (Constitution of Operation Jig)

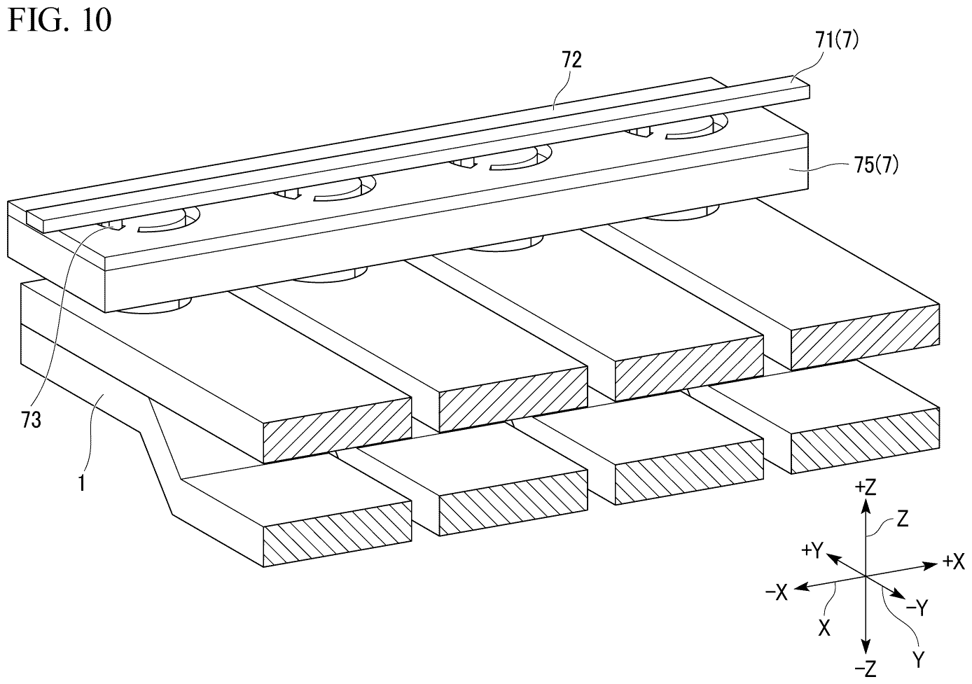

The operation jig 7 is a jig for operating the plurality of connection structures 1 and 101. As illustrated in FIG. 10, the operation jig 7 includes a bar 71 and a cover 75. Hereinafter, a case where the operation jig 7 is applied as a jig for operating the plurality of connection structures 1 will be described. Note, however, that the same applies to the case where the operation jig 7 is used as a jig for operating the plurality of connection structures 101.

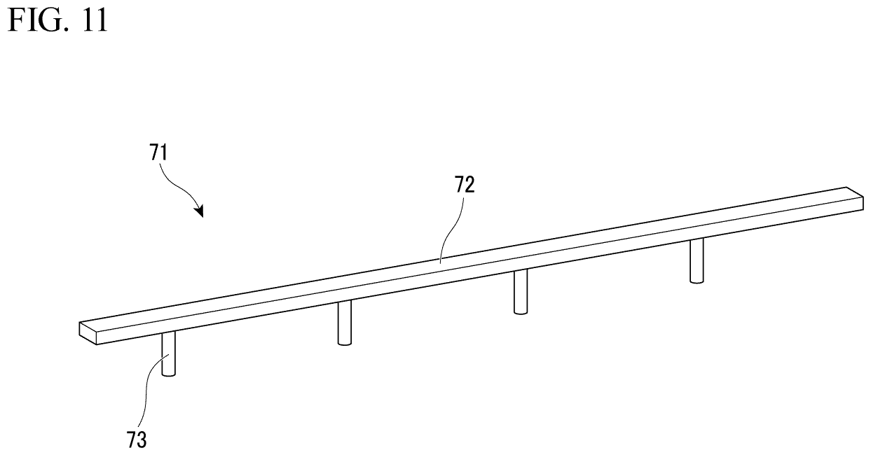

(Constitution of Bar) As illustrated in FIGS. 10 and 11, the bar 71 includes an extending portion 72 and a plurality of pins 73.

The extending portion 72 extends in the X direction. The plurality of pins 73 are arranged in the X direction at the same pitch as the pitch at which the plurality of connection structures 1 are arranged in the X direction. Each pin 73 extends toward the corresponding connection structure 1 in the Z direction so as to protrude from the extending portion 72.

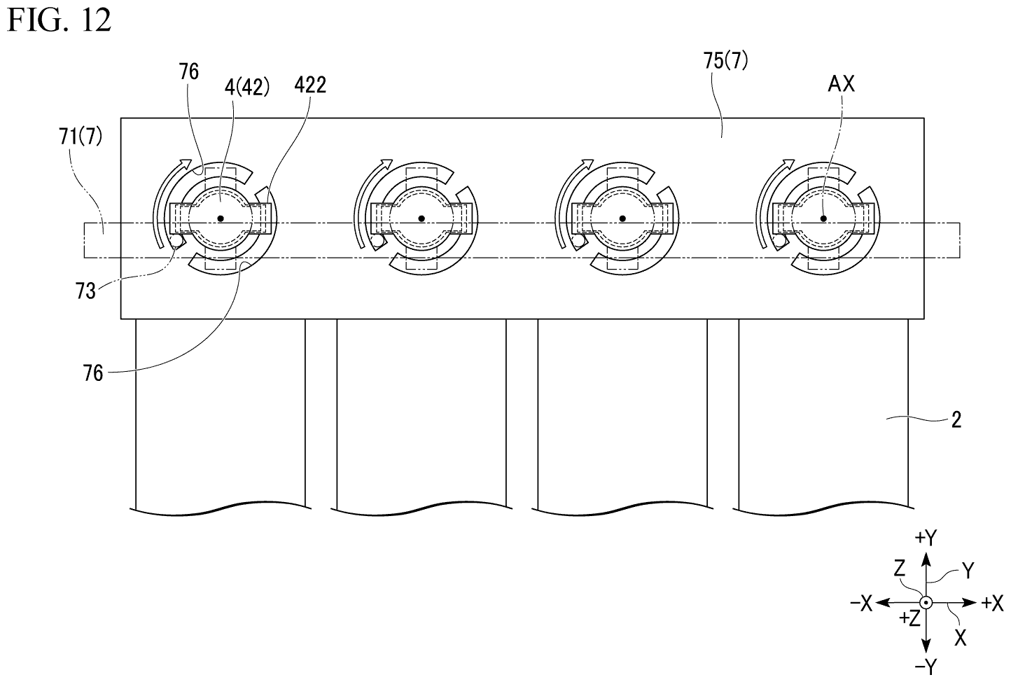

(Constitution of Cover) As illustrated in FIG. 12, the cover 75 extends in the X direction. The cover 75 is provided between the extending portion 72 and a device bus bar 2 in the Z direction. The cover 75 has a plurality of arcuate openings 76.

The plurality of arcuate openings 76 are provided in a pair for each connection structure 1. Each arcuate opening 76 is open from the bar 71 side to the device bus bar 2 side. In each connection structure 1, each of the pair of arcuate openings 76 has an arcuate shape along the rotation track of the corresponding first protrusion 422 of a pair of first protrusions 422. For example, the pair of arcuate openings 76 may have arcuate shapes point-symmetric with respect to an axis AX and may be provided at point-symmetric positions.

### (Operation Method)

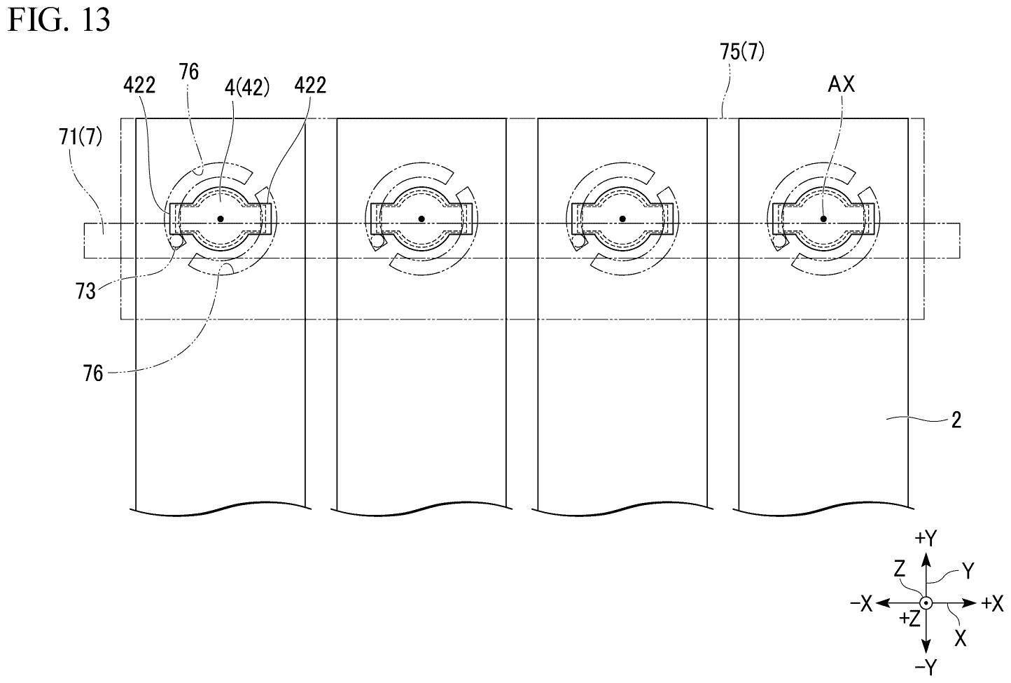

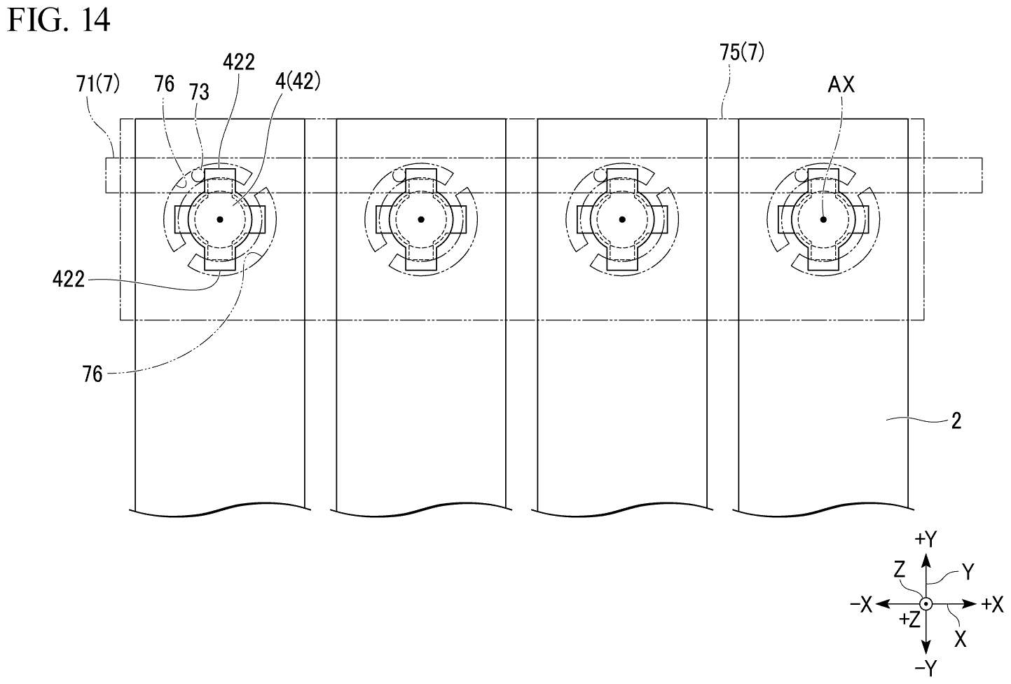

The operator installs the bar 71 on the device bus bar 2 with the cover 75 interposed therebetween, such that each pin 73 is fitted in one of the pair of arcuate openings 76 of the corresponding connection structure 1. At this time, as illustrated in FIG. 13, in each connection member 4, the pair of first protrusions 422 are arranged in the X direction.

Next, the operator presses a first overhanging portion 42 in the −Z direction while fixing the cover 75 to the device bus bar 2 in the XY plane.

Next, while pressing the cover 75, the operator operates the bar 71 to simultaneously rotate the plurality of connection members 4 across the plurality of connection structures 1 in the XY plane while hooking the pins 73 on first protrusions 422. With this rotation, the device bus bar 2 and a battery bus bar 3 are connected by a plurality of connection members 4.

### (Operation and Effect)

According to the operation jig 7 of the present embodiment, the plurality of connection structures 1 arranged in the parallel direction can be collectively rotated. The arcuate opening 76, i.e., the operation jig 7 facilitates the operation of the plurality of connection structures 1.

Further, according to the operation jig 7 of the present embodiment, the connection member 4 can be operated along the rotation track of the first protrusion 422 by the arcuate opening 76. Therefore, the operator can easily rotate the connection member 4.

### (Modification)

In the present embodiment, a pair of arcuate openings 76 are provided for each connection structure 1. Note, however, that if each connection member 4 can be rotated, it is possible to provide only one arcuate opening 76 of the pair of arcuate openings 76 for each connection structure 1.

In the present embodiment, one arcuate opening 76 of the pair of arcuate openings 76 is used for the rotation of the connection member 4. Note, however, that as a modification, in addition to one arcuate opening 76, the other arcuate opening 76 may also be used. In the present modification, a pair of bars 71 are prepared for one cover 75. The operator hooks the pin 73 of one bar 71 of the pair of bars 71 on one first protrusion 422 of the pair of first protrusions 422 of each connection member 4 through one arcuate opening 76. Further, the operator hooks the pin 73 of the other bar 71 of the pair of bars 71 on the other first protrusion 422 of the pair of first protrusions 422 of each connection member 4 through the other arcuate opening 76. The operator rotates the connection member 4 with the pair of bars 71 hooked on the pair of first protrusions 422. According to such a modification, by using two bars 71, the force at the time of rotation necessary for rotating the connection member 4 can be shared by the two bars 71. Therefore, the minimum force needed to rotate the connection member 4 is reduced.

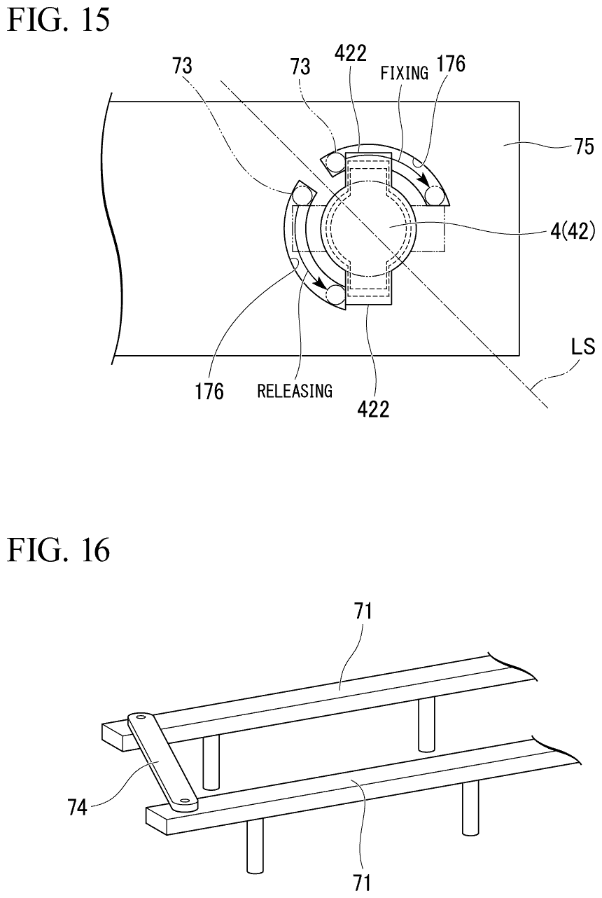

In the present embodiment, the pair of arcuate openings 76 have arcuate shapes point-symmetric with respect to the axis AX and are provided at point-symmetric positions. Note, however, that as long as each connection member 4 can be rotated, the pair of arcuate openings 76 may have any shape and positional relationship. As a modification, as illustrated in FIG. 15, instead of the pair of arcuate openings 76, a pair of arcuate openings 176 may have arcuate shapes line-symmetric with respect to a symmetry line LS and may be provided at line-symmetric positions. In this constitution, one arcuate opening 176 of the pair of arcuate openings 176 can be used for fixing a connection member 4, and the other arcuate opening 176 can be used for releasing the connection member 4. According to such a modification, since the rotation angle of the connection member 4 is determined by the shape of the hole, it is easy to control the rotation angle of the connection member 4.

In the modifications described above, the bars 71 are provided in a pair. In these modifications, one of the pair of bars 71 is provided corresponding to one of the pair of arcuate openings 76 and 176. Further, the other of the pair of bars 71 is provided corresponding to the other of the pair of arcuate openings 76 and 176. In such a modification, furthermore, as illustrated in FIG. 16, a pair of bars 71 may be connected to one another by means of a link 74 such that the spacing therebetween can be varied.

### Other Modifications

In each of the above embodiments, the operator operates the operation jig 7. Note, however, that the operation jig 7 may be operated in any manner as long as the connection member 4 can be operated by the operation jig 7. As a modification, an operation device may perform the operation to be performed by the operator. For example, the operation device may operate the operation jig 7 according to a command of the operator.

In the example of each of the above-described embodiments, the outline of the first overhanging portion 42 has a similar shape to the outline of the second overhanging portion 43. Note, however, that as long as the connection member 4 can connect the device bus bar 2 and the battery bus bar 3, the outline of the first overhanging portion 42 may have any outline shape. As a modification, the outline of the first overhanging portion 42 may have a non-similar shape to the outline of the second overhanging portion 43. According to this modification, the shape of the first overhanging portion 42 can be freely designed regardless of the outline shape of the second overhanging portion 43.

In the example of each of the above-described embodiments, the second overhanging portion 43 includes the second disk 431 and the pair of second protrusions 432. Note, however, that as long as the connection member 4 can connect the device bus bars 2 and 102 and the battery bus bars 3 and 103, the second overhanging portion 43 may have any outline shape. As a modification, the second overhanging portion 43 may have the second disk 431 and only one second protrusion 432 of the pair of second protrusions 432. According to this modification, the structure of the second overhanging portion 43 can be further simplified. As another modification, the second overhanging portion 43 may have three or more second protrusions 432. According to this other modification, since the number of points where the second overhanging portion 43 is caught on the second pressed surfaces 32 and 122 can be increased, the connection member 4 can stably connect the device bus bars 2 and 102 as the first bus bars and the battery bus bars 3 and 103 as the second bus bars.

In the example of each of the above-described embodiments, the elastic member 5 is a coil spring. Note, however, that any member may be used as long as it is a member for applying a biasing force to press the device bus bars 2 and 102 toward the battery bus bars 3 and 103. As a modification, the elastic member 5 may be a rubber bush, a disc spring, or the like that can be inserted into the shaft 41. In addition, these elastic members 5 may be formed of a conductive material such as metal, or may be formed of an insulating material such as rubber or resin.

In the example of each of the above-described embodiments, the inner peripheral diameter DA5 of the elastic member 5 is smaller than the first disk 421 of the first overhanging portion 42, but may be any inner peripheral diameter as long as it is smaller than the maximum diameter of the first overhanging portion 42. Note, however, that when the inner peripheral diameter DA5 of the elastic member 5 is smaller than the first disk 421 of the first overhanging portion 42, the elastic member 5 is easily held between the first overhanging portion 42 and the first pressed surfaces 22 and 132.

While the embodiments of the present disclosure have been described above, the embodiments are shown as examples and are not intended to limit the scope of the present disclosure. This embodiment can be implemented in various other forms, and various omissions, substitutions, and changes can be made without departing from the gist of the present disclosure.

### INDUSTRIAL APPLICABILITY

According to the connection structure, the assembly, and the operation jig of the present disclosure, it is easy to secure the contact pressure of a conductor.

### BRIEF DESCRIPTION OF THE REFERENCE SYMBOLS

1 Connection structure
2 Device bus bar (first bus bar)
3 Battery bus bar (second bus bar)
4 Connection member
5 Elastic member
7 Operation jig
9 Assembly
21 First facing surface
22 First pressed surface
23 First through hole
23a First peripheral surface
23b First recessed surface
31 Second facing surface
32 Second pressed surface
33 Second through hole
33a Second peripheral surface
33b Second recessed surface
41 Shaft
41a First end
41b Second end
42 First overhanging portion
43 Second overhanging portion
71 Bar
72 Extending portion
73 Pin
74 Link
75 Cover
76 Arcuate opening
91 Device
92 Battery pack
92h Hole
93 Fastener
94 First installation surface
95 Housing
96 Flange
97 Second installation surface
101 Connection structure
102 Device bus bar (second bus bar)
103 Battery bus bar (first bus bar)
121 Second facing surface
122 Second pressed surface
123 Second through hole
123a Second peripheral surface
123b Second recessed surface
131 First facing surface
132 First pressed surface
133 First through hole
133a First peripheral surface
133b First recessed surface
176 Arcuate opening
421 First disk
422 First protrusion
431 Second disk
432 Second protrusion
AA Region
AX Axis
CC Virtual circle
CV Recess
DA5 Inner peripheral diameter
DB5 Outer peripheral diameter
DR Radial direction
LS Symmetry line
OP Opening
RP1 First rotational position
RP2 Second rotational position

What is claimed is:

1. A connection structure comprising:
a first bus bar having a first facing surface, a first pressed surface on a back side of the first facing surface, and a first through hole penetrating from the first pressed surface to the first facing surface in a penetrating direction that is a direction intersecting the first facing surface;
a second bus bar having a second facing surface facing the first facing surface, a second pressed surface on a back side of the second facing surface, and a second through hole penetrating from the second facing surface to the second pressed surface in the penetrating direction;
a connection member including a shaft that has a first end and a second end and extends in the penetrating direction from the first end to the second end so as to communicate with the first through hole and the second through hole, a first overhanging portion that protrudes from the first end in a radial direction of the shaft, and a second overhanging portion that protrudes from the second end in the radial direction; and
an elastic member through which the shaft penetrates,
wherein the first through hole is defined by a first peripheral surface having a cross-sectional shape along a circumference of a virtual circle and extending from the first facing surface to the first pressed surface, and a first recessed surface having a cross-sectional shape recessed from the circumference and extending from the first facing surface to the first pressed surface,
the second through hole is defined by a second peripheral surface having a cross-sectional shape along the circumference and extending from the second facing surface to the second pressed surface, and a second recessed surface having a cross-sectional shape recessed from the circumference and extending from the second facing surface to the second pressed surface,
the elastic member has an outer peripheral diameter larger than the circumference and an inner peripheral diameter smaller than a maximum diameter of the first overhanging portion,
the second overhanging portion is insertable into the first through hole and the second through hole while being fitted into a recess defined by the first recessed surface and the second recessed surface at a first rotational position around an axis of the shaft, and
the second overhanging portion overlaps the second pressed surface when viewed in the penetrating direction at a second rotational position around the axis.

2. The connection structure according to claim 1, wherein
the first overhanging portion includes a first disk having an outer peripheral diameter larger than the inner peripheral diameter.

3. The connection structure according to claim 2, wherein
the first overhanging portion further includes a first protrusion protruding further from the first disk in one direction in the radial direction,
the second overhanging portion includes a second disk having an outer peripheral diameter smaller than the circumference, and a second protrusion protruding further from the second disk in the radial direction, and
the second protrusion protrudes in the one direction in which the first protrusion protrudes.

4. The connection structure according to claim 1, wherein
an outline of the second overhanging portion has a similar shape to an outline of the first overhanging portion when viewed in the penetrating direction.

5. An assembly comprising:
the connection structure according to claim 1;
a battery pack connected to one of the first bus bar and the second bus bar; and
a device connected to the other of the first bus bar and the second bus bar.

6. An operation jig comprising
a bar including an extending portion extending in a parallel direction in which a plurality of the connection structures according to claim 1 are arranged, and a plurality of pins each extending from the extending portion toward the corresponding first pressed surface in the penetrating direction; and
a cover extending in the parallel direction and having a plurality of openings each opened in an arc shape along a rotation track of the corresponding first overhanging portion.
